(19) United States
(12) Patent Application Publication
(10) Pub. No.: US 2016/0075246 A1
(43) Pub. Date: Mar. 17, 2016

(54) METHOD OF BRANCH CIRCUIT CAPACITY UTILIZATION FOR ELECTRIC VEHICLE CHARGING

(71) Applicant: SCHNEIDER ELECTRIC USA, INC., Palatine, IL (US)

(72) Inventor: Julius Michael LIPTAK, Knightdale, NC (US)

(73) Assignee: SCHNEIDER ELECTRIC USA, INC., Palatine, IL (US)

(21) Appl. No.: 14/784,670

(22) PCT Filed: Apr. 26, 2013
(86) PCT No.: PCT/US13/38473

§ 371 Date: Oct. 15, 2015

(51) Int. Cl. B60L 11/18; H02H 3/08

(52) U.S. Cl. CPC B60L 11/1838; B60L 11/1851; B60L 11/1816; H02H 3/08

(57) ABSTRACT

Dynamic adjustment of a charge rate of an EVSE on a shared branch circuit, ensuring maximum power delivery to the EVSE without overloading the branch circuit. The Level 1 EVSE and at least one other load are connected to the branch circuit via different electrical outlets. A current monitoring circuit continuously monitors the total current flowing through the branch circuit, and a communications link is established between the monitoring circuit and the EVSE. When the monitored current on the branch circuit is about to exceed a set point corresponding to a rated current capacity of the branch circuit, the charge rate is reduced to maximize power delivery to the EVSE without overloading the branch circuit. The charge rate is increased when more current is available to be drawn from the branch circuit to ensure continuous and uninterrupted delivery of maximum power to the EVSE without exceeding the rated current capacity.

### FIELD OF THE INVENTION

The present disclosure relates to electric vehicle charging systems, and, more particularly, to methods and systems of dynamically adjusting a charge rate of an electric vehicle supply equipment (EVSE) by monitoring total current flowing through a branch circuit to which the EVSE is connected.

### BACKGROUND

Electric vehicles can be charged in a garage by plugging the electric vehicle into an electric vehicle supply equipment (EVSE) that includes a Level 1 charging circuit for charging the battery of the electric vehicle. While it is recommended that a dedicated branch circuit be used for the EVSE, in reality, some existing homes may not heed this recommendation, and instead users will plug the electric vehicle into an available standard wall outlet. But the typical homeowner will not necessarily know or care about the particulars of the electrical wiring from the wall outlet to the circuit breaker, and typically the wall outlet is part of a branch circuit on which other outlets are also connected. Thus, motorized devices in particular such as freezers, power drills, or the like plugged into these other outlets and turned on will take current from the same branch circuit, creating a potential risk of overloading the branch circuit and tripping the circuit breaker.

A problem with connecting a Level 1 charging circuit to a branch circuit on which other auxiliary loads are also connected, is that all loads on the shared branch circuit will try to draw as much current as they need to support their immediate electrical demands. When that demand exceeds the available current rating of the branch circuit, the branch circuit breaker will trip. The customer who, after plugging in an electric vehicle to the EVSE Level 1 charger in the garage, and then expected to wake up in the morning to a fully charged electric vehicle, will be rather disappointed. As soon as the total load on the branch circuit is exceeded, the circuit breaker will trip, interrupting the flow of current to all of the loads until the circuit breaker is manually reset.

Conservative approaches suspend or stop charging altogether when another load demands current from a shared branch circuit, but this is hardly an optimal solution because no charging occurs while the EVSE is off. Moreover, frequent stopping and restarting the charging of the electric vehicle's battery can degrade the battery and adversely affect its lifespan.

What is needed is a method and system for dynamically adjusting a charge rate of the EVSE on a shared branch circuit to which the EVSE and at least one other load is connected.

### BRIEF SUMMARY

Methods and systems are disclosed for dynamically adjusting a charge rate of the EVSE on a shared branch circuit, where the EVSE shares the same branch circuit with other loads. A current sensor monitors the total current drawn by all of the loads on the branch circuit, regardless of which electrical outlet the loads are plugged into. Thus, if a freezer and an EVSE are plugged into different outlets but share the same branch circuit, the current sensor monitors all of the current demanded by both the freezer and the EVSE.

Knowing the total amount of current flowing through the shared branch circuit allows an algorithm or control scheme to adjust the average charge rate of the electric vehicle by ensuring that a maximum amount of power is supplied to the EVSE, as much as the branch circuit is rated for, without overloading the branch circuit or tripping the circuit breaker. This monitoring is done continuously and so is the adjustment of the charge rate. If a freezer motor suddenly turns on, causing an inrush of current to be demanded by the freezer on the branch circuit, the charge rate of the EVSE is dynamically reduced by an amount that prevents the branch circuit from becoming overloaded but still allows a maximum amount of current to be supplied to the EVSE while also meeting the sudden demand of the freezer. When the freezer motor reaches its steady state and settles down, the charge rate of the EVSE is dynamically increased such that a maximum amount of power is delivered to the EVSE without overloading the branch circuit. This control scheme allows for a continuous and uninterrupted flow of current to the EVSE as the load demand on the branch circuit varies. Of course, if the non-EVSE loads on the branch circuit begin to draw too much current such that any charge rate of the EVSE would cause the branch circuit to overload, the charging can be suspended until the loading decreases to a point where charging can resume. A set point, such as corresponding to a percentage of a rated current capacity (e.g., 80% of 15A) of the branch circuit, can be established and used by the control scheme as a threshold. If the set point is exceeded for an amount of time, the charge rate can be reduced or suspended until the current load on the branch circuit falls back below the set point.

### BRIEF DESCRIPTION OF THE DRAWINGS

FIG. 1 is a functional block diagram of a system configured to dynamically adjust a charge rate of an EVSE connected to a shared branch circuit to which another load is also connected, according to an aspect of the present disclosure;

FIG. 2 is a functional block diagram of an example system in which an EVSE and a freezer are connected to the same branch circuit, and a total current flowing through the branch circuit is monitored by a current sensor coupled to the branch circuit conductor;

FIG. 3 is a flowchart diagram of an example algorithm for dynamically adjusting a charge rate of the EVSE shown in FIG. 1 or 2, according to an aspect of the present disclosure.

### DETAILED DESCRIPTION

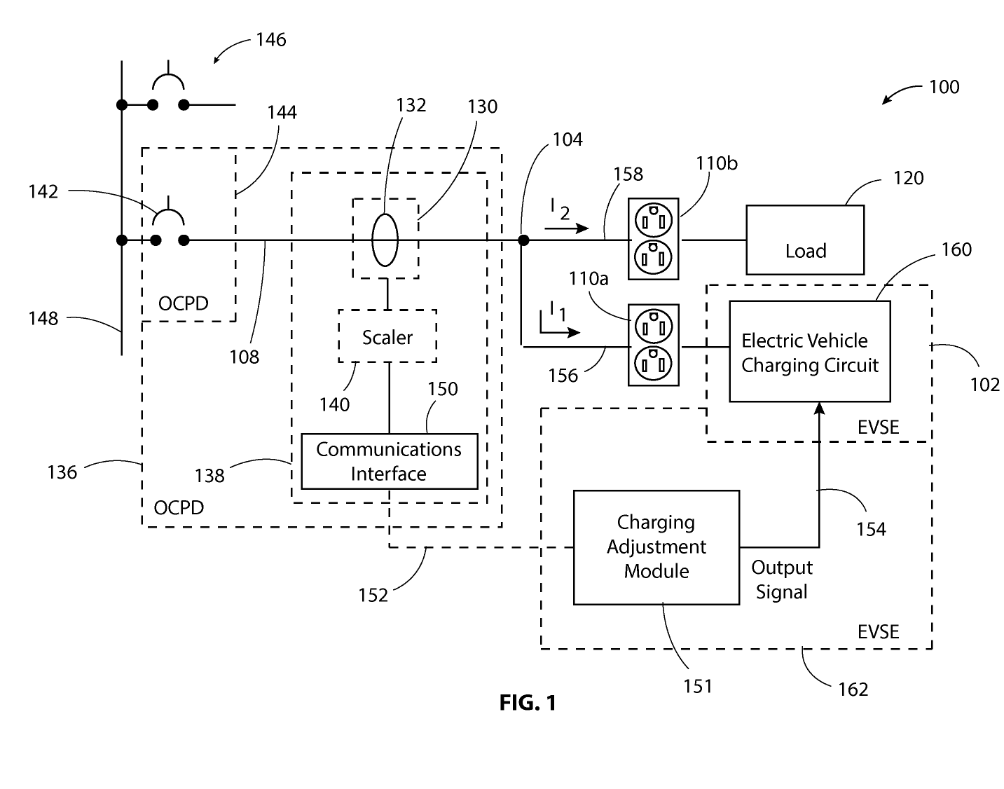

FIG. 1 is a functional block diagram of a system 100 configured to dynamically adjust a charge rate of an electric vehicle supply equipment (EVSE) 102 on a shared branch circuit. The term “branch circuit” is used as that term is understood by those skilled in the art of electrical distribution systems. The term EVSE as used herein is also variously known as an electric vehicle charging station (EVCS) or charging point. An EVSE is an apparatus that supplies electric energy for recharging a plug-in electric vehicle whose drivetrain is moved by an electric motor powered by a rechargeable battery system. The EVSE includes a standardized connector that complies with the SAE (Society of Automotive Engineers) J1772 standard or the IEC (International Electrotechnical Commission) 62916 standard, and this connector conventionally plugs into a mating connector in the electric vehicle. An EVSE can be connected to a public utility grid, which supplies energy to charge a battery of an electric vehicle. In this disclosure, the EVSE 102 can be a residential charger configured to connect to an existing 15A or20A 120V standard electrical outlet. Charging from this type of EVSE is known as Level 1 charging, though the present disclosure is not limited to Level 1 charging and contemplates that the EVSE 102 can support Level 2 charging. In other jurisdictions, the electrical outlets are rated for 220/240V, and the present disclosure is not limited to the specific current and voltage ratings of the branch circuits described herein. The maximum steady-state power for a 15A or 20A branch circuit is typically about 1.4 kW or 1.9 kW, respectively.

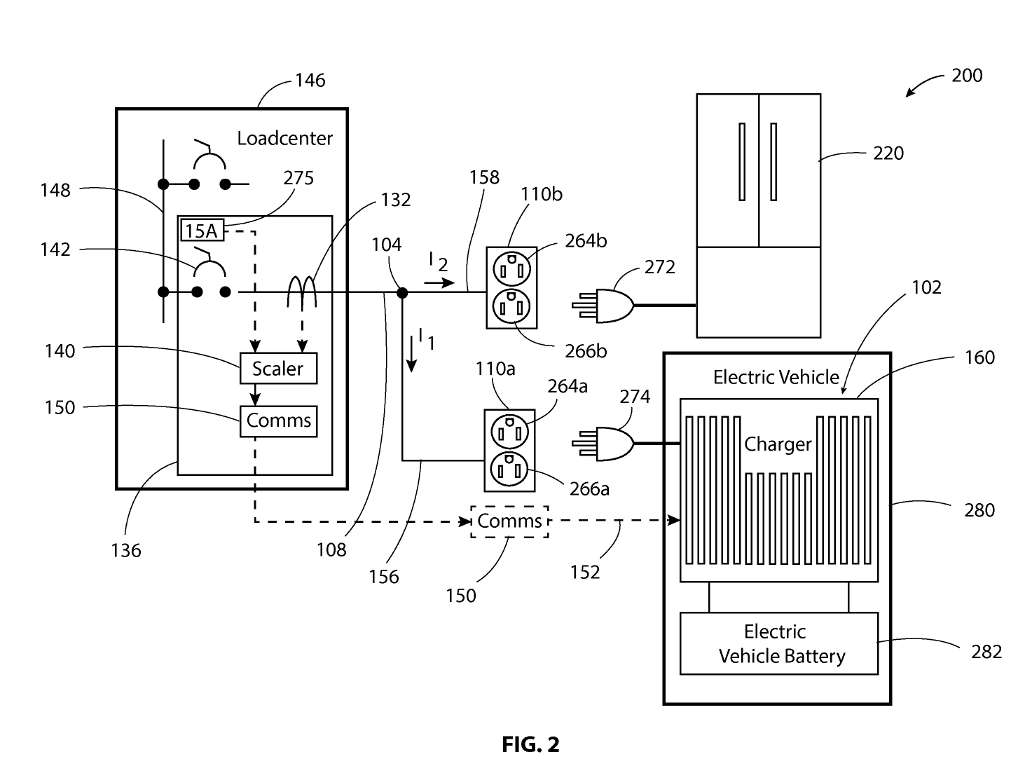

The system 100 includes the EVSE 102 connected to a first non-dedicated electrical outlet 110a on a branch circuit 104. The branch circuit 104 feeds at least two non-dedicated electrical outlets, the first electrical outlet 110a and a second non-dedicated electrical outlet 110b to which an other or auxiliary load 120 is connected. By non-dedicated, it is meant that the outlets share the same branch circuit and are not connected to their own dedicated branch circuit. A dedicated outlet, by contrast, would be free to use the entire capacity of the branch circuit 104, and no other outlets would be connected to that branch circuit. The auxiliary load 120 can, for example, be a load having a motor, such as a freezer, a power tool, or an HVAC device, which demands a high starting current before settling on a steady state current during normal operation as defined by the motor's nameplate. Because the branch circuit 104 feeds at least two non-dedicated electrical outlets 110a, 110b, each load 102, 120 can demand different levels of current, designated as I₁ and 1₂, respectively, at different times. Thus, the total current flowing through the branch circuit is a function of the respective currents I₁ and 1₂ drawn by the loads 102, 120 connected to the corresponding non-dedicated outlets 110a, 110b. The branch circuit 104 is protected by an overcurrent protection device (OCPD) 142, such as a circuit breaker in a loadcenter 146 (best seen in FIG. 2), which trips in response to an electrical fault occurring on or relative to the branch circuit 104, thereby interrupting the flow of electrical current from a line (feeder) conductor 148 connected to the loadcenter 146 to the branch circuit 104 and thereby to the first and second electrical outlets 110a, 110b. In this example, the branch circuit 104 is shown to be connected to two different and non-dedicated electrical outlets 110a, 110b, each being connected by different sets of conductors to the branch circuit 104, but in other examples, more than two electrical outlets can be connected to the branch circuit 104. Note that a conventional wall outlet may have a pair sockets surrounded by a faceplate as shown in FIG. 2, but in this example both sockets are wired to a single set of conductors (line and neutral) to the branch circuit 104. By “different electrical outlets,” it is meant that each set of sockets (thereby forming a single electrical outlet) is connected to the branch circuit 104 by different sets of wire conductors. Thus, the term “socket” refers to herein as the wall-mounted, accessible electrical socket into which a plug is inserted, but an “outlet” is characterized by the wiring that is connected to the branch circuit 104. A non-dedicated electrical outlet 110a or 110b can have a pair of sockets (264a, 266a) or (264b, 266b), such as shown in FIG. 2, but has only one set of wire conductors 156 or 158, one line and one neutral, feeding the branch circuit 104.

The current flowing through the branch circuit 104 is monitored by a current monitoring circuit 130 that includes a current sensor 132 coupled to a conductor 108 of the branch circuit 104. The current sensor 132 can be any conventional current transformer configured to sense a characteristic of electrical current flowing through the conductor 108 and provide an output representative of a value (such as a voltage) that is proportional to the current flowing through the conductor 108. For example, the current sensor 132 can include a Rogowski coil, and can have a toroid shape featuring an open center through which the conductor 108 passes. It should be understood that the current sensor 132 is not limited to current transformers. Other current sensors such as shunts or Hall effect devices can be utilized.

The output of the current sensor 132 can be in the form of a voltage, for example, which is proportional to the magnitude of the total current (e.g., I₁ +I₂) flowing through the conductor 108 of the branch circuit 104. This output can be scaled or magnified by an optional scaler circuit 140, which converts the voltage value into a corresponding digital value or scales the voltage value to a range acceptable for an analog-to-digital converter. If scaled by the scaler circuit 140, the digital or scaled value produced by the scaler circuit 140 is provided to a wired or wireless communications interface 150.

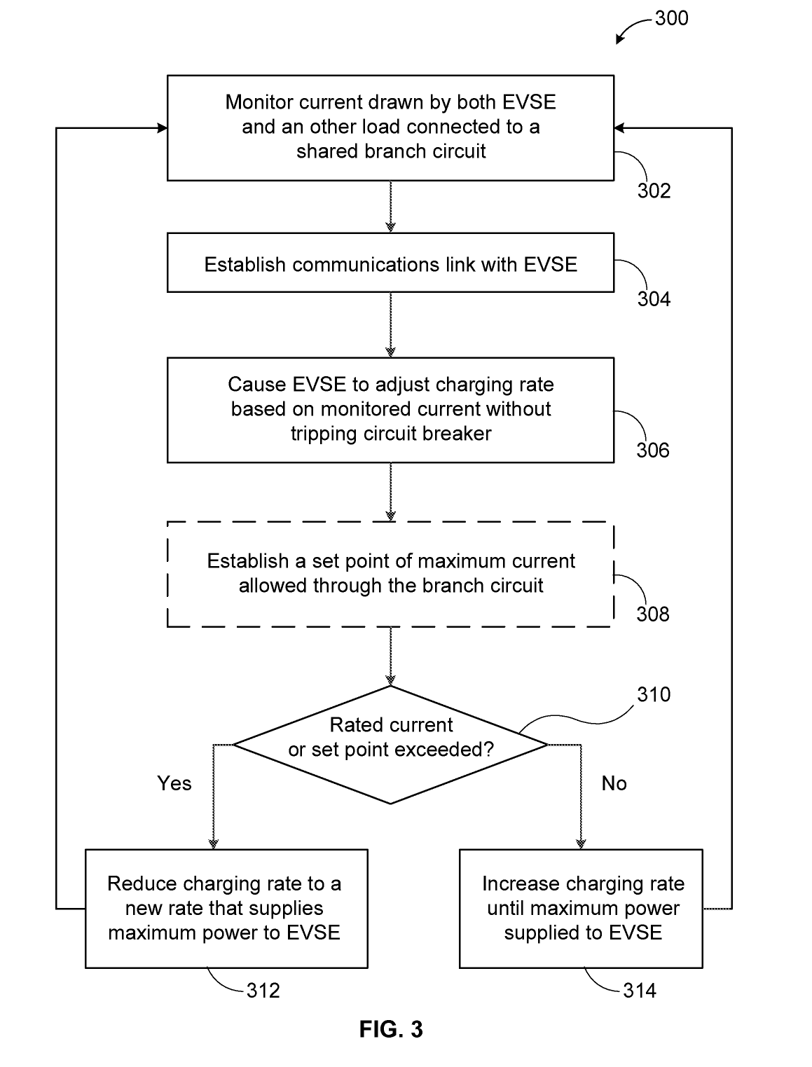

The system 100 further includes a charging adjustment module 151, which is configured to receive a representation of the monitored current (e.g., a voltage or digital value representative of the magnitude of current flowing through the branch circuit 104) and produce an output signal 154 to adjust a charging level (e.g., a charge rate) of a charging circuit 160 of the EVSE 102. The representation of the monitored current is received via the communications interface 150 over a wired or wireless communications link 152. The charging adjustment module 151 can include discrete electronic components configured to produce the output signal 154, or the charging adjustment module 151 can be realized in logic circuitry, firmware, or software, or any combination of logic circuitry or hardware or software/firmware components. For example, the charging adjustment module 151 can include discrete electronic components such as a comparator that compares the monitored current representation with a set point 275 (described below), and/or an analog-to-digital converter to convert an analog representation (such as a voltage) of the monitored current to a corresponding digital value for communication to the charging circuit 160. The charging adjustment module 151 can include a controller or processor that optionally includes an analog-to-digital converter, and the controller can be programmed to carry out an algorithm, such as the algorithm 300 described below in connection with FIG. 3. As used herein, a “charging level” can refer to a charge rate of a battery, such as the electric vehicle battery 282 shown in FIG. 2.

The various components of the system 100 shown in FIG. 1 can be arranged in different housings or enclosures as follows. For example, the overcurrent protection device 142 includes a housing, designated by 136, in which the current monitoring circuit 130, the optional scaler circuit 140, and the communications interface 150 are disposed. Alternately, the current monitoring circuit 130, the optional scaler circuit 140, and the communications interface 150 can be disposed in a housing 138, which is distinct from a housing or enclosure 144 that encloses the OCPD 142. For example, if the OCPD 142 is a conventional circuit breaker, the current monitoring circuit 130, the optional scaler circuit 140, and the communications interface 150 can be supplied as an add-on or standalone component to the OCPD 142, which can be housed within a panel of the loadcenter 146 or outside the panel of the loadcenter 146. The toroid coil of the current sensor 132 can be separated to wrap around the conductor 108 of the branch circuit 104. If the communications interface 150 is a wireless interface, no further installation steps are needed. Alternately, the communications interface 150 can communicate instructions or other data signals according to a power line carrier (PLC) communication protocol over the conductor 108 to the charging adjustment module 151 when it is powered by the first electrical outlet 110a.

The EVSE 102 can be a conventional EVSE 102 with a conventional housing or enclosure, and the charging adjustment module 151 can be supplied as an add-on or standalone component that has its own housing or enclosures separate from that of the EVSE 102 and connects wirelessly to the EVSE 102 or through a connector to supply the output signal 154 to the charging circuit 160. Or, the EVSE can include the charging adjustment module 151 within the same housing or enclosure, as designated by reference number 162 in FIG. 1.

Exemplary methods of dynamically adjusting a charge rate of an EVSE 102 on a shared branch circuit will be described next, with reference to FIGS. 1 and 2. FIG. 2 illustrates an example system 200, which is based on the system 100 shown and described in FIG. 1. In FIG. 2, like reference numbers shown in FIG. 2 refer to like elements shown in FIG. 1. In FIG. 2, the auxiliary load 120 is a freezer 220, having a plug 272 that is plugged into one of two sockets 264b, 266b of the second electrical outlet 110b connected to the branch circuit 104. The EVSE 102 includes a plug 274 that is plugged into one of the two sockets 264a, 266a of the first non-dedicated electrical outlet 110a also connected to the branch circuit 104. Also shown is an electric vehicle 280 having an electric vehicle battery 282 that is charged according to an adjustable charge rate as commanded by the charging circuit 160.

What follows are different approaches for dynamically adjusting a charge rate of the EVSE 102 on a shared branch circuit 104. “Dynamically adjusting” means in real-time so that a charging circuit 160 of the EVSE 102 continues to charge the electric vehicle battery 282 while the other load 120, 220 continues to be powered by the branch circuit 104 without tripping the OCPD 142. It is not necessary that the charging circuit 160 cease or suspend charging the electric vehicle battery 282 merely because the other load 120, 220 demands additional current (e.g., when the freezer motor turns on, it will demand a high starting current). An average rate of charge can be constantly adjusted so that a maximum power is continuously delivered to support the battery charging functions of the EVSE 102 without overloading the branch circuit 104 beyond its rated current capacity (e.g., 15 A or 20 A) or without tripping the OCPD 142. An awareness of the current demanded by the branch circuit 104 is used to determine how to adjust the average charge rate of the charging circuit 160. The handle rating of the OCPD 142 can be exceeded for a short period of time without tripping the OCPD 142, and the algorithm according to the present disclosure can allow an excessive amount of current to be supplied to the branch circuit 104 for a period of time that does not exceed the preconfigured time-current characteristic trip curves of the OCPD 142. In an example, a set point 275 is established of a maximum current flow through the branch circuit 104. This set point 275 can exceed the rated current capacity of the branch circuit 104. But in an example, the set point 275 can be set to correspond to the rated current capacity of the branch circuit 104, which in typical configurations is 15 A or 20 A. In this example, it is not necessary to monitor the time that the rated current capacity of the branch circuit 104 is exceeded, because the OCPD 142 should not trip as long as the time-current trip characteristics are not exceeded.

Exemplary methods (300) of dynamically adjusting a charge rate of the EVSE 102 on a shared branch circuit will be described next with reference to FIG. 3. The current drawn by all of the loads 102, 120 on the shared branch circuit 104 is monitored by the current monitoring circuit 130 (302). The loads 102, 120 are connected to the shared branch circuit 104 by different non-dedicated electrical outlets 110a, 110b, respectively. A wired or wireless communications link 152 is established between the current monitoring circuit 130 and the EVSE 102 (304). The method or algorithm 300 causes the EVSE 102 to adjust a charge rate of the charging circuit 160 by communicating, to the EVSE 102 over the communications link 152, a representation based on the monitored current, without tripping the OCPD 142 (306). By “causes,” it is meant that a component or signal external to the charging circuit 160 (such as the charging adjustment module 151) influences or instructs the EVSE 102 to adjust the charge rate of the charging circuit 160. The representation can include a value or percentage by which the charge rate is to be adjusted by increasing or decreasing the charge rate. Or, the representation can include a value corresponding to a voltage or scaled voltage proportional to the magnitude of the monitored current, which the EVSE 102 uses to determine how much to adjust the charge rate of the charging circuit 160.

The charging adjustment module 151 causes the EVSE 102 to adjust the charge rate of the charging circuit 160 while the charging circuit 160 continues to supply power to charge the electric vehicle battery 282 and without suspending or stopping the delivery of power to the electric vehicle battery 282 from the charging circuit 160. In other words, the charge rate is adjusted simultaneously as the magnitude of current drawn by the other load 120, 220 varies so that the combined current from both the charging circuit 160 and the other load 120, 220 does not continuously exceed the rated current capacity of the branch circuit 104. In the example shown in FIG. 2, the other load 220 is a freezer having a motor that initially demands a starting current on startup that greatly exceeds a steady state current demanded by the freezer 220 by at least twofold. This sudden surge in current demanded by the branch circuit 104 will cause a commensurate reduction in the charge rate of the charging circuit 160. The combined currents may exceed the rated continuous current capacity of the branch circuit for a short time while the charger responds to the command to reduce charge rate. Both loads will continue to operate with the charging circuit 160 operating at a reduced rate. If the other load 220 draws an overcurrent as may happen during a malfunction and the rated current capacity of the branch circuit is continuously exceeded, OCPD 142 trips and interrupts the flow of current to the branch circuit 104.

The EVSE 102 can be instructed to adjust the charge rate by reducing or increasing the charge rate as a function of the current demanded by the other load(s) 120, 220 on the same shared branch circuit 104. If the charging adjustment module 151 detects that the monitored current is causing the rated current capacity of the branch circuit 104 to be exceeded, the charging circuit 160 is instructed to reduce its charge rate to a new charge rate that supplies a maximum power to the EVSE 102 while keeping a total current demand by the branch circuit 104 below the rated current of the branch circuit 104 or within a preconfigured time-current characteristic trip curve of the OCPD 142. By contrast, if the charging adjustment module 151 detects that a current demanded by the other load(s) 120, 220 decreases, the charging circuit 160 is instructed to increase its charge rate to a new charge rate that supplies the maximum power to the EVSE 102 while keeping a total current demand by the branch circuit 104 below its rated current or within a preconfigured time-current characteristic trip curve of the OCPD 142.

As mentioned above, an optional set point 275 can be established corresponding to a maximum current flow allowable through the branch circuit 104 (308). Note, as mentioned above, this set point 275 can correspond to a value that exceeds the rated current capacity of the branch circuit 104, and if so, the charging adjustment module 151 ensures that the total current demand is not exceeded for a period of time specified by characteristic trip curve of the OCPD 142. Thus, if the set point 275 exceeds the rated current capacity of the branch circuit 104, at least two criteria are taken into consideration by the charging adjustment module 151: monitored current and a length of time the monitored current exceeds the rated current capacity; whereas if the set point 275 is set at or below the rated current capacity of the branch circuit 104, the charging adjustment module 151 need only take into account the monitored current. Additional examples of the set point will be explained further below. The set point 275 can be established (308), for example, by storing a data representation of the set point 275 in a memory device or register for comparison with the monitored current from the current monitoring circuit 130. Conversely, the setpoint 275 can be implied and implemented by appropriate scaling of the signal from the current sensor 130 via the scaler 140. As an example, a value of “100” transmitted by the scaler 140 to the charging adjustment module 151 can represent a value of 100% of rated branch circuit current capacity. The transfer characteristic of the scaler 140 is set so that when the magnitude of current equivalent to 100% rated branch circuit current flows through conductor 108, a value of “100” will be transmitted. In this way, the charging adjustment module can work with percentage computations instead of actual current magnitude computations.

Other examples of the set point 275 include a fixed current value, such as 15 A or 20 A, a percentage value, such as 0.8 or 1.2 of the handle rating of the circuit breaker 142, or a function that includes current and time variables. In the case of a fixed value, the charging adjustment module 151 compares the monitored current values from the current monitoring circuit 130 (as optionally scaled by the scaler circuit 140), with the set point 275 to determine whether the monitored current exceeds the set point (310) (this determination can be absolute or within a predetermined tolerance). If so, the algorithm 300 reduces the charge rate to a new charge rate that supplies maximum power to the EVSE 102 (312). By “maximum power,” it is meant here that the total current demand by both loads 102, 120 does not exceed the set point 275. Thus, for example, if the set point 275 is fixed at 15 A, and the other load 120 is drawing 7 A, then the charge rate of the EVSE 102 will be established to draw no more than 8 A, or just below 8 A if an absolute comparison is made. By way of another example, as noted above, the set point 275 can be set at a value that exceeds the rated current capacity of the branch circuit 104 so long as the time-current characteristic trip curve of the OCPD 142 is not exceeded. Thus, for example, the set point 275 can be set at 110% of the rated current capacity (e.g., 16.5 A when the rated capacity is 15 A), and the charging adjustment module 151 ensures that the total current drawn by the branch circuit 104 does not exceed the rated current capacity for a time longer than the time-current characteristic trip curve of the OCPD 142 permits. By way of still another example, the set point 275 can be a function that is based on the time-current characteristic trip curve for the OCPD 142. For example, the function can be set to correspond exactly to the time-current characteristic trip curve for the OCPD 142 or to be shifted slightly below the time-current characteristic trip curve for the OCPD 142.

Returning to block 312, the charge rate can be reduced by a fixed amount immediately to a point where the EVSE 102 draws a level of current that will not cause the total current consumed by both loads 102, 120 to exceed the rated current capacity of the branch circuit 104, or in fixed or variable steps or increments over time as the charging adjustment module 151 continuously monitors to ensure that the set point 275 is not exceeded, or according to a function that first rapidly reduces the charge rate but then tapers off with a feedback loop to settle on an optimum charge rate. Because the current sensor 132 monitors the branch circuit 104 feeding all of the non-dedicated outlets 110a, 110b, the algorithm 300 can very quickly adapt to different loading of the branch circuit 104, allowing an optimal and uninterrupted delivery of a maximum amount of energy to the charging circuit 160 even while other loads 120 are present on the same branch circuit 104.

Returning to block 310, if the set point 275 is not exceeded, the charging adjustment module 151 causes the charging circuit 160 of the EVSE 102 to increase its charge rate to a new charge rate until a maximum power is supplied to the EVSE 102, where the maximum power refers to the highest amount of power that can be delivered when the power delivered to the other load(s) 120 on the same branch circuit are taken into consideration without exceeding the set point 275 or without tripping the OCPD 142 (314). As noted above in connection with block 312, the charge rate can be increased by a fixed amount or in fixed or variable steps or increments over time or according to a function.

The algorithm 300 causes the EVSE 102 to adjust the charge rate continuously to supply uninterrupted, continuous, and variable charging to the EVSE 102 as current demanded by the loads 102, 120 on the branch circuit 104 vary. Even if additional loads, such as other appliances or tools, are plugged into other outlets also on the same branch circuit 104, the algorithm 300 can adaptively handle any amount of loading on the branch circuit 104 and optimally adjust the charge rate of the charging circuit 160 in real time to supply uninterrupted charging to the EVSE 102. However, if the total load on the branch circuit 104 will exceed the OCPD's handle rating or the current capacity of the branch circuit 104, the EVSE 102 can be commanded to stop or suspend charging of the battery 282 until such time as the total current load on the branch circuit 104 falls below the set point 275. On the other hand, if the other load 120 is unplugged or turned off, and there are no other loads drawing current from the branch circuit 104, the charging circuit 160 is free to use the entire current capacity of the branch circuit. Time-of-day electrical rate structures can be taken into consideration by the algorithm 300. For example, the algorithm 300 can reduce the charging rate of the charging circuit 160 during periods where the delivery rates are high, or initiate charging the battery 282 when delivery rates are low.

The elegance of the algorithm 300 and other methods disclosed herein is in their simplicity. The total branch current is considered, and only a single control variable (i.e., the charge rate of the EVSE 102) is adjusted based on the branch current measurements.

Some or all of the blocks shown in FIG. 3, described by way of example herein, represent one or more algorithms 300 that correspond to at least some instructions executed by the one or more controllers to perform the functions or steps disclosed. Any of the methods or algorithms or functions described herein can include machine or computer-readable instructions for execution by: a processor or controller, and/or any other suitable processing device. Any algorithm, software, or method disclosed herein can be embodied as a computer program product having one or more non-transitory tangible medium or media, such as, for example, a flash memory, a CD-ROM, a floppy disk, a hard drive, a digital versatile disk (DVD), or other memory devices, but persons of ordinary skill in the art will readily appreciate that the entire algorithm and/or parts thereof can alternatively be executed by a device other than a controller and/or embodied in firmware or dedicated hardware (e.g., it can be implemented by an application specific integrated circuit (ASIC), a programmable logic device (PLD), a field programmable logic device (FPLD), discrete logic, etc.).

What is claimed is:

1. A method of dynamically adjusting a charge rate of an EVSE on a shared branch circuit, comprising:
monitoring, by a current monitoring circuit, a current drawn by all loads on the shared branch circuit, to which the EVSE and an other load are both connected;
establishing a communications link between the current monitoring circuit and the EVSE; and
causing the EVSE to adjust a charge rate of a charging circuit of the EVSE, by communicating, to the EVSE over the communications link, a representation based on the monitored current, without overloading the branch circuit beyond a rated current capacity of the branch circuit.

2. The method of claim 1, wherein the causing the EVSE to adjust the charge rate is carried out without tripping an overcurrent protection device that is protecting the branch circuit and to which the branch circuit is connected and while the charging circuit continues to supply power.

3. The method of claim 1, wherein the causing the EVSE to adjust the charge rate is carried out simultaneously as a magnitude of current drawn by the other load is varying such that both the battery of the electric vehicle and the other load draw current from the same shared branch circuit.

4. The method of claim 1, wherein the charging circuit is a Level 1 charging circuit that is connected to a first of the electrical outlets.

5. The method of claim 4, wherein the first electrical outlet is a 15 A or 20 A receptacle.

6. The method of claim 1, wherein the other load includes a motor having a starting current that exceeds a steady state current by at least twofold.

7. The method of claim 1, wherein the causing the EVSE to adjust the charge rate includes:
causing the EVSE to reduce the charge rate, in response to a rated current of the branch circuit being exceeded, to a new charge rate that supplies a maximum power to the EVSE while keeping a total current demand by the branch circuit below the rated current; or
causing the EVSE to increase the charge rate, in response to the other load decreasing a current demand on the branch circuit, to a new charge rate that supplies the maximum power to the EVSE while keeping a total current demand by the branch circuit below the rated current.

8. The method of claim 1, further comprising establishing a set point of maximum current flow through the branch circuit, wherein the causing the EVSE to adjust the charge rate includes:
responsive to the set point being exceeded, causing the EVSE to reduce the charge rate to a new charge rate that supplies a maximum power to the EVSE without exceeding the set point or,
responsive to the total current load on the branch circuit falling below the set point, causing the EVSE to increase the charge rate to a new charge rate that supplies the maximum power to the EVSE without exceeding the set point.

9. The method of claim 8, wherein the set point corresponds to a percentage of a rated current capacity of the branch circuit.

10. The method of claim 1, wherein the causing the EVSE to adjust the charge rate is carried out continuously to supply uninterrupted, continuous, and variable charging to the EVSE as current demanded by the loads on the branch circuit vary.

11. A system of dynamically adjusting a charge rate of an EVSE on a shared branch circuit, comprising:
a current monitoring circuit including a current sensor coupled to a conductor of a branch circuit, the current sensor monitoring a current through the branch circuit, the branch circuit connecting to a plurality of electrical outlets;
a communications interface coupled to the current sensor; and
a charging adjustment module configured to receive the representation of the monitored current and produce based on the representation an output signal to adjust a charge rate of a charging circuit of an EVSE coupled to the communications interface and connected to a first of the electrical outlets while an other load is connected to a second of the electrical outlets without tripping an overcurrent protection device that is protecting the branch circuit.

12. The system of claim 11, wherein the current monitoring circuit and the communications interface are disposed within a housing of the overcurrent protection device.

13. The system of claim 11, wherein the charging adjustment module is disposed within the EVSE.

14. The system of claim 11, wherein the current monitoring circuit is disposed within a housing distinct from the overcurrent protection device and the EVSE.

15. The system of claim 11, wherein the charging adjustment module is configured to:
responsive to a set point being exceeded, cause the EVSE to reduce the charge rate to a new charge rate that supplies a maximum power to the EVSE without tripping the overcurrent protection device, wherein the set point corresponds to an amount of current flow through the branch circuit; or
responsive to the total current load on the branch circuit falling below the set point, cause the EVSE to increase the charge rate to a new charge rate that supplies the maximum power to the EVSE without tripping the overcurrent protection device.

16. The system of claim 15, wherein the set point corresponds to a percentage of a rated current capacity of the branch circuit.
